(19) United States
(12) Patent Application Publication
(10) Pub. No.: US 2016/0074785 A1
(43) Pub. Date: Mar. 17, 2016

(54) Inspectable Oil Filter

(71) Applicants: Glenn Smith, West Palm Beach, FL (US); Kendra Blash-Smith, West Palm Beach, FL (US)

(72) Inventors: Glenn Smith, West Palm Beach, FL (US); Kendra Blash-Smith, West Palm Beach, FL (US)

(21) Appl. No.: 14/845,663

(22) Filed: Sep. 4, 2015

Related U.S. Application Data
(60) Provisional application No. 62/050,832, filed on Sep. 16, 2014.

(51) Int. Cl. B01D 35/143; B01D 29/11; B01D 35/30

(52) U.S. Cl. CPC B01D 35/143; B01D 35/30; B01D 29/11

(57) ABSTRACT

An engine oil filter is provided that comprises a transparent sidewall for inspecting the oil content within the oil filter interior. The oil filter comprises an oil filter housing with a filter element, a center tube, a base plate, and a biasing member that maintains the filter element in position within the filter housing. The filter housing has a sidewall that comprises a transparent material, thereby allowing inspection of the oil within the filter without having to first remove the filter from an engine. Also provided is an oil condition indicator that allows a user to compare the color of the oil within the oil filter housing to one or more oil reference markers. The oil condition indicator is used to determine when the oil has reached its usable life and when the oil must be replaced.

### CROSS REFERENCE TO RELATED APPLICATION

This application claims the benefit of U.S. Provisional Application No. 62/050,832 filed on Sep. 16, 2014. The above identified patent application is herein incorporated by reference in its entirety to provide continuity of disclosure.

### BACKGROUND OF THE INVENTION

### Field of the Invention

The present invention relates to engine lubrication systems and engine oil filters. More specifically, the present invention relates to an engine oil filter that comprises a transparent sidewall for inspection purposes.

Engines requires lubrication to reduce friction between moving elements in contact with one another. Engine oil prevents wear and ensures smooth operation of an engine by providing sufficient lubrication between contact surfaces. Engine oil has a useful life, after which time the viscosity of the oil increases and its ability to lubricate moving parts reduces. In particular, engine oil retains particulates, dirt, and even small metal shavings from the engine as the engine is operated. Over time, the oil will become full of particulates and will require replacement in order to continue properly lubricating the engine.

To extend the useful life of engine oil, engines include an oil filter. The oil filter generating includes an oil filter housing with a filer element therein that removes particulates from the oil as the oil is forced through the filter. However, even with engine oil filters, the oil must be regularly replaced. Vehicle owners and mechanics are very familiar with the process of replacing engine oil. Generally, a predetermined service interval establishes when to inspect and replace the oil. During the oil change, the oil is drained and replaced, and the oil filter is replaced. The condition of the oil is only inspectable using a dip stick, or upon inspection as the oil is being drained.

However, some modern cars do not provide a dip stick to inspect the oil level or the condition of the oil. For these vehicles, the condition of the oil is checked upon replacement, whereby the oil is replaced based on an interval and not upon actual condition of the oil. The present invention provides an oil filter housing that can be used to check the condition of the oil independent of a dip stick and between scheduled intervals. This may be particularly important for vehicles that are used in dirty environments, those not used often enough and sit for long periods between oil change intervals, and finally for those that wish to check the oil or save time and money by checking the oil without first committing to replacing the same.

The present invention comprises an inspectable oil filter that comprises an oil filter housing with a transparent sidewall. The sidewall of the oil filter housing is transparent to allow a user to inspect the oil quality within the oil filter, thereby allowing the user to determine if the oil is in proper working condition, or if the oil must be replaced. The color and viscosity of the oil can be viewed through the transparent sidewall without first removing the oil filter housing and committing to changing the engine oil. This saves time and money. Further provided is an oil condition indicator that can be used as a reference or meter against the visible oil within the filter housing.

It is submitted that the present invention provides a new and useful oil filter device. It is further submitted that the present invention fulfills certain objectives and needs in the art, including those identified above, as well as other not explicitly discussed above. This background section should not be construed as limiting the oil filter of the present invention as serving a singular purpose or addressing only those needs discussed above. Rather, this section is designed to discuss some potential benefits and uses of the present invention, and should not be read as limiting the claims.

### SUMMARY OF THE INVENTION

The following summary is intended solely for the benefit of the reader and is not intended to be limiting in any way. The present invention provides a new oil filter device that can be utilized for inspecting the quality and content of oil within the oil filter without removing the same.

It is therefore an object of the present invention to provide a new and improved oil filter device that has all of the advantages of the prior art and none of the disadvantages.

It is another object of the present invention to provide an oil filter device that comprises a filter housing having a first end, a second end, an interior, and sidewalls extend between the first end and the second end. The sidewalls of the filter housing further comprise a transparent material that allows visual inspection of oil within filter housing though the sidewalls when the filter housing is in a working state.

Another object of the present invention is to provide an oil filter device that comprises an oil filter housing with a base plate disposed over the second end thereof, the baseplate having oil inlet apertures therethrough for allowing oil to pass into the interior of the filter housing. The oil filter housing further comprises a threaded aperture for securing the filter housing to a threaded member of an engine, and a center tube disposed within the interior of the filter housing that aligns with the threaded aperture of the base plate.

Yet another object of the present invention is to provide an oil filter device with a center tube that has an elongated length, a tubular sidewall, and apertures therethrough to allow oil to enter the interior of the center tube after passing through an oil filter element. The center tube further comprises an open first end and an open interior that aligns with the threaded aperture of the baseplate for allowing oil to exit the oil filter housing after it has been filtered.

Another object of the present invention is to provide an oil filter device that comprises a filter element disposed around the center tube and within the interior of the filter housing. The oil filter element removes particulates from the engine oil and filters the engine oil before it is forced into the center tube and out of the oil filter housing.

Another object of the present invention is to provide an oil filter device that comprises a biasing member disposed between the first end of the filter housing and the filter element within the interior of the filter housing. The biasing member maintains the position of the filter as engine oil is passed therethrough.

Another object of the present invention is to provide an oil filter device that has sidewalls comprising a transparent material, the transparent material being one that allows visual inspection through the sidewalls and into the interior of the filter housing to view the condition of the engine oil. The transparent material may comprises one of several suitable materials. Examples include plastic materials, thickened glass, or composites thereof.

Another object of the present invention is to provide an oil filter device that comprises an oil condition indicator along the filter housing that is used to compare the engine oil to a metric using color indicators. The indicator includes one or more oil colors to compare the condition of the oil in the filter to the indicator colors.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the inspectable oil filter of the present invention.

FIG. 2 shows a cut-away view of the oil filter of the present invention, including its internal components.

FIG. 3 shows another view of the oil filter of the present invention, including a close-up view of the oil condition indicator.

### DETAILED DESCRIPTION OF THE INVENTION

Reference is made herein to the attached drawings. Like reference numerals are used throughout the drawings to depict like or similar elements of the oil filter device of the present invention. For the purposes of presenting a brief and clear description of the present invention, the preferred embodiment will be discussed as used for filtering engine oil while allowing visual inspection of the oil condition within the oil filter without first removing the same from the engine. The figures are intended for representative purposes only and should not be considered to be limiting in any respect.

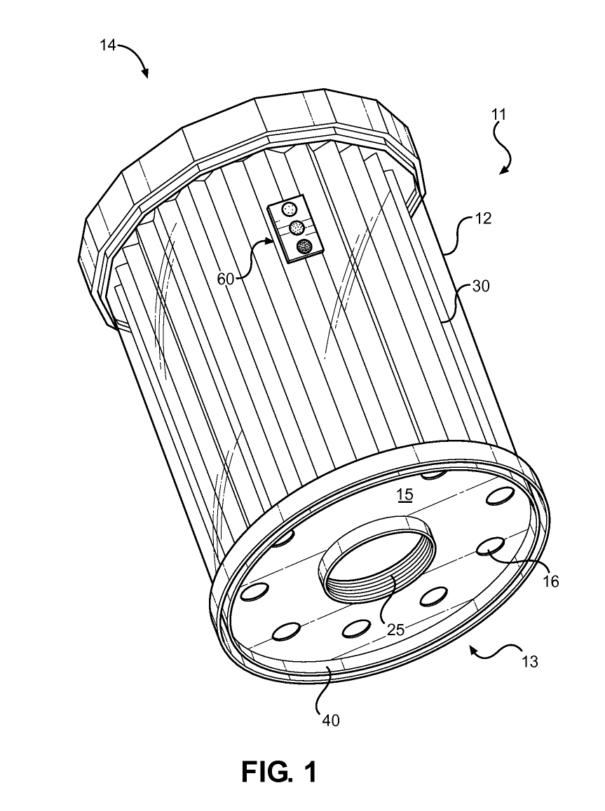

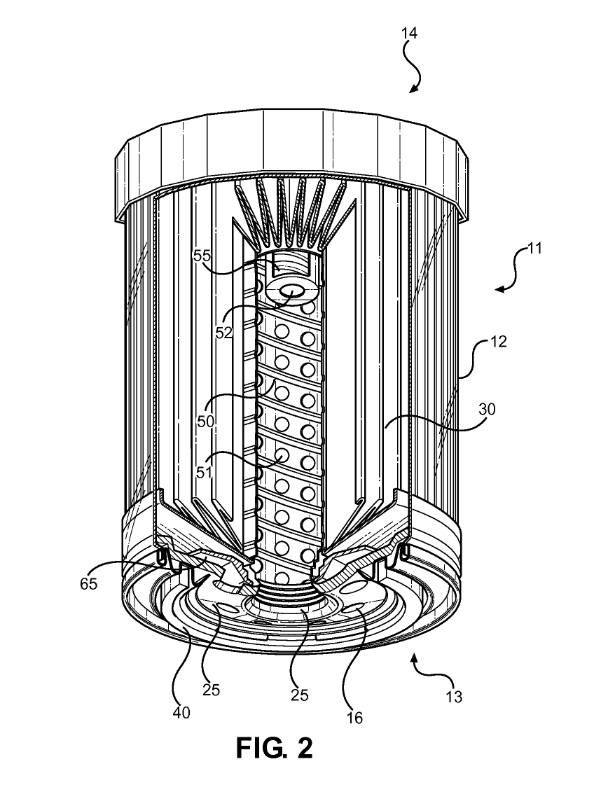

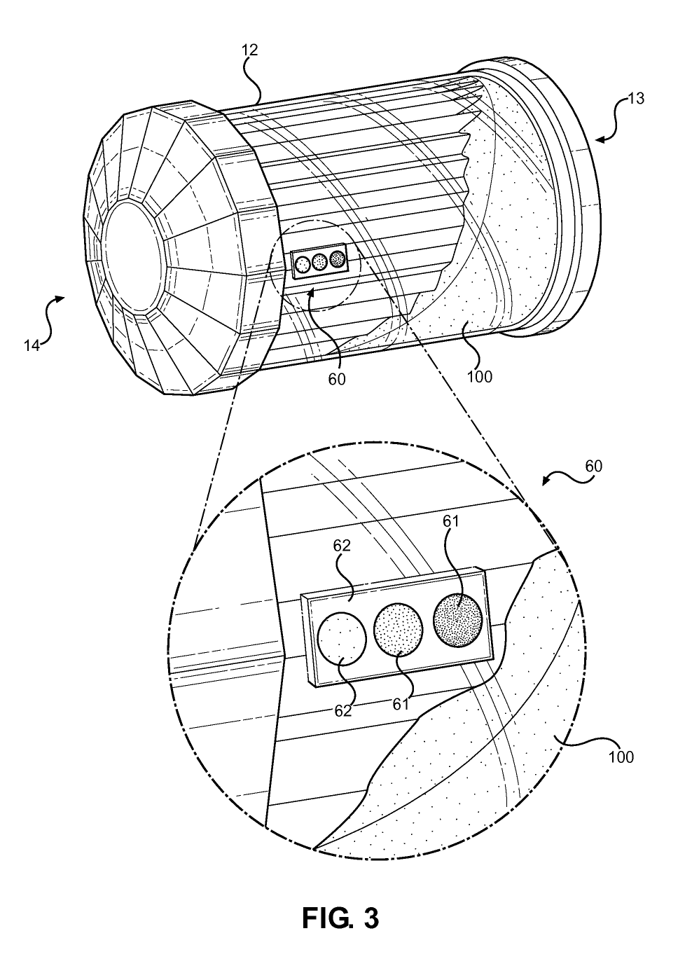

Referring now to FIGS. 1-3, there are shown embodiments of the oil filter device of the present invention. The oil filter device comprises an oil filter housing 11 that is adapted to receive oil therein, filter to the oil within its interior, and allow the filtered oil to be expelled from the housing 11. The oil filter housing 11 comprises a first end 14, a second end 13, an interior, and sidewalls 12 that extend between the first end 14 and the second end 13. Within the interior of the housing 11 is an oil filter element 30 that filters oil of particulates as it passes therethrough.

Along the second end 13 of the housing 11 is a base plate 15 that is adapted to abut against an engine and allow oil to communicate therethrough. The base plate 15 comprises a centrally located aperture 25 and a plurality of oil inlet apertures 16 along its surface. The centrally located aperture 25 is an oil outlet aperture that allows filtered oil to exit the housing 11 and reenter the engine. The oil inlet apertures 16 allow pressurized oil to flow from the engine and into the interior of the housing 11, whereafter it passes through the oil filter element 30. Once the oil has passed through the filter element 30, the oil passes through a center tube 50 disposed within the interior of the housing 11. The oil then travels along the center tube 50 and through the oil outlet aperture 25. The oil outlet aperture is preferably a threaded aperture that threadably affixes to a threaded member on the engine to secure the housing 11 thereto. When the housing 11 is threadably affixed to the engine, a filter gasket 40 disposed along the base plate 15, outboard of the apertures, seals the base plate 15 to the engine to prevent oil leakage across the threshold of this connection.

A biasing member 55 maintains the oil filter element 30 in position within the housing interior while oil passes therethrough. The biasing member 55 may comprises a spring, a biased bracket, or similar member that maintains the filter 30 in a static condition within the interior of the housing 11. The filter element 30 is disposed about the center tube 50, which includes apertures 51 or louvers to allow filtered oil to pass therethrough and into the hollow interior of the center tube 50. The center tube 50 comprises an elongated length and a tubular sidewall, whereby the center tube 50 has an open first end and an open interior that aligns with the oil outlet aperture (i.e. the threaded aperture) of the baseplate 15 for allowing oil to exit the oil filter housing 11. The filter element is disposed around the center tube and is maintained against the baseplate 15 by the biasing member 55. A relief valve 52 may further be provided within the center tube 50 and along the first end 14 of the housing interior, which prevents of restrictions and maintains the flow of oil within the center tube, and thus oil back into the engine. Finally, an anti-drain back seal 65 may be provided to prevent unfiltered and filtered oil from interacting within the housing interior.

The housing unit comprises one or more sidewall 12 extending between the first and second ends thereof. The sidewall 12 comprises a transparent material that allows visual inspection of oil within filter housing 11 though the sidewall. This allows a user to inspect the condition of the oil without removing the filter or draining the oil, whereby the filter can maintain a working state during inspection. The transparent material comprises one that allows visual inspection of the interior of the oil filter housing, thereby allowing the user to see the color, consistency, and viscosity of the engine oil therein. Embodiments of the transparent material include clear plastic material, thickened glass, composites thereof, and other materials with transparent properties. The transparency of the sidewall 12 may be coextensive with its entire surface area, as depicted in FIGS. 1-3, or attentively the transparency may extend for only apportion thereof. In this instance, the transparent portion of the sidewall provides a viewing window through the sidewall and into the interior of the oil filter housing.

The shape of the filter housing 11 may take on several forms, falling within the scope of providing a fully transparent or partial viewing window through the sidewall thereof. In particular, the housing 11 may include a singular, rounded sidewall as depicted in FIGS. 1-3. Alternatively, the housing 11 may comprise different cross sectional shapes and may be comprised of more than one continuous surface. For instance, the housing 11 may have several faceted sidewalls, forming a rectangular, hexagonal, or alternative shape with flat sidewalls. The exact shape, dimension, and design of the housing may take on several different forms and is not limited to those embodiments shown in the drawing views.

To assist the user when inspecting the oil condition through the transparent sidewall 12 of the housing 11, an oil condition indicator 60 is provided. The oil condition indicator 60 is a legend, or metric, upon which a user can compare against the color of the engine oil within the filter housing. Several embodiments are contemplated for the oil condition indicator 60. The first embodiment comprises a static indicator 60 having an oil color legend, whereby at least two oil color reference markers 61 are provided. Each of the oil color reference markers 61 indicates a condition of the oil. Another embodiment comprises a testing paper 62 that reacts to the condition of the oil. The oil contacts the testing paper 62, and the testing paper changes color based on the condition of the oil. When the testing paper 62 indicates the oil is to be changed, the user can drain the oil and replace the filter. Similarly, when the oil color matches one of the oil color reference markers 61 that indicates a condition that requires replacement, the user can drain the oil and replace the oil filter.

Overall, the present invention provides a way to promptly detect problems and issues regarding engine oil condition. Viewing the engine oil through the filter housing is a faster and more economical alternative than prematurely changing engine oil based on intervals alone. The device includes a transparent sidewall and a color-coded indicator that can be used to inspect the oil and alert users of oil quality. The invention reduces the potential for damage to engine parts and eliminates the need to track mileage, or guess when an oil filter needs to be changed. The invention accommodates various vehicles such as ATVs, marine vehicle, trucks, cars and the like.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An oil filter that can be inspected for oil condition without removal of the oil filter, comprising:
a filter housing having a first end, a second end, an interior, and a sidewall extending between the first end and the second end;
a base plate disposed over the second end of the filter housing, the baseplate having oil inlet apertures therethrough for allowing oil to pass into the interior of the filter housing;
the baseplate further comprises a threaded aperture for securing the filter housing to a threaded member of an engine;
a center tube disposed within the interior of the filter housing, the center tube having an elongated length, a tubular sidewall, and apertures therethrough;
the center tube further comprising an open first end and an open interior that aligns with the threaded aperture of the baseplate for allowing oil to exit the oil filter housing;
a filter element disposed around the center tube and within the interior of the filter housing;
a biasing member disposed between the first end of the filter housing and the filter element within the interior of the filter housing; and
wherein the sidewall of the filter housing comprises a transparent material that allows visual inspection of oil within filter housing therethrough when the filter housing is in a working state;
an oil condition indicator that includes one or more oil colors to indicate the condition of the oil in the filter.

2. The oil filter of claim 1, wherein the transparent material further comprises a clear plastic material.

3. The oil filter of claim 1, wherein the transparent material further comprises a glass material.

4. The oil filter of claim 1, wherein the base plate further comprises a gasket disposed along an outer surface thereof to seal the oil inlet apertures and the threaded aperture of the baseplate against an engine.

5. The oil filter of claim 1, further comprises an anti-drain back seal disposed between the filter element and the base plate.

6. The oil filter of claim 1, wherein the sidewalls further comprises a rounded shape, whereby the oil filter housing has a substantially cylindrical body.

7. The oil filter of claim 1, wherein the oil condition indicator further comprises:
an oil color legend having at least two oil color reference markers, whereby each of the oil color reference markers indicates a condition of the oil.

8. The oil filter of claim 1, wherein:
the sidewall further comprises a surface area; and
wherein the transparent material is coextensive with the surface area of the sidewall.

9. The oil filter of claim 1, wherein:
the sidewall further comprises a surface area; and
wherein the transparent material is not coextensive with the surface area of the sidewall and forms a viewing window therethrough.
